(19) United States
(12) Patent Application Publication
(10) Pub. No.: US 2007/0275228 A1
(43) Pub. Date: Nov. 29, 2007

(54) Tackable furniture panels having foam substrates

(76) Inventor: Bruce S. Castor, Fort Lee, NJ (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 11/402,456

(22) Filed: Apr. 11, 2006

(51) Int. Cl. B32B 3/00

(52) U.S. Cl. 428/317.1; 428/314.4

(57) ABSTRACT

Substrates having tackable surfaces are disclosed. Such a substrate may include a tackable foam sheet and a pressure sensitive adhesive layer affixed to the tackable foam sheet. The pressure sensitive adhesive layer may include a pressure sensitive adhesive and a release backing. A furniture panel having a tackable surface may include a rigid core layer, a tackable foam layer affixed to the rigid core layer, and a covering material affixed to the rigid core layer that at least partially covers a tackable surface of the foam layer. The rigid core layer may include a fiberglass. The tackable foam layer may include a cross-linked, closed-cell, polyolefin foam, which may be a polypropylene foam. The tackable foam layer may have a thickness of about 1 to 6 mm, a density of about 1.5 to 4 lb/ft³, a compressive strength of more than about 0.3 kg/cm², and a gel fraction of about 30-40%. The tackable foam layer may be adhered to the rigid core layer, via a pressure sensitive adhesive, for example. The covering may be wrapped around the tackable foam layer and the rigid core layer sufficiently tightly to affix the tackable foam layer to the rigid core layer via friction between the tackable foam layer and the rigid core layer. The furniture panel may include a frame that receives the tackable foam layer and the rigid core layer such that the tackable foam layer is affixed to the rigid core layer.

### BACKGROUND OF THE INVENTION

Typical furniture panels, such as office partitions and stretch walls, for example, may include a covering material, such as a fabric, for example, that is tightly-stretched over, and affixed to, an underlying substrate. Many such furniture panels have tackable surfaces.

As used herein, the term “tackable” refers to the ability of a material (or composite system) to hold a tack under the weight of an object that is tacked into the material. That is, a “tackable” material, as that term is used herein, refers to a material from which a tack does not pull out appreciably even under the weight of an object, such as a paper or photograph, for example, that is tacked into the surface of the material. The more “tackable” a material is, the more weight a tack pressed into the material can hold.

Also as used herein, the term “tackable substrate” refers to a three-dimensional bulk of tackable material. The term “tackable surface” refers to an externally-accessible, two-dimensional boundary of a tackable material or composite system. The term “tackable panel” refers to a composite system having a tackable surface. A “tack” may refer to a thumb tack, push pin, or other such object, for example.

A typical furniture panel may have a rigid core, which may be made of fiberglass having a thickness in a range of about ½-2″ and a density in a range of about 1.5-6#. Examples of such fiberglass include rotary processed fiberglass, such as Owens Corning's RA and Johns Manville's SG products, for example.

A tackable substrate may be affixed to the fiberglass core. In typical furniture partition applications, the tackable substrate may be a molded fiberglass board having a thickness in a range of about ⅛-¼″ and a density in a range of about 12-22 lbs/ft³. Examples of such molded fiberglass boards include known products made by Quite Core, Molded Acoustical, and the like.

An adhesive may be used to adhere the fiberglass board to the core. An example of such an adhesive is a wet applied adhesive, such as those manufactured by National Starch or HB Fuller, for example. The adhesive may be spread or sprayed onto the core. The board may then be pressed onto the adhesive, which is then allowed to dry or cure. Thus, the board may be affixed to the core.

The panel may also include a covering, which may be, for example, any fabric suitable for the purpose of adding aesthetic value to the assembly, such as a cloth or vinyl, for example. The covering may be wrapped around the fiberglass board, and secured to the back side of the core, for example, via an adhesive or other securing means, such as a staple, tack, or screw, for example. It should be understood that the covering may be wrapped tightly enough around the board so that friction holds the board against the core. Accordingly, an adhesive may not be necessary to affix the board to the core.

Another embodiment of such a panel may include a septum, which may be a wallboard, chipboard, cardboard, metal plate, etc. Typically, such a septum may have a thickness in a range of about ⅛-3″. A molded fiberglass board may be affixed to the septum. The molded fiberglass board may be a tackable substrate, having a thickness in a range of about ⅛-¼″, and a density in a range of about 12-22 lbs/ft³.

An adhesive, such as Mon-Eco Industries' 22-08, for example, may be used to adhere the fiberglass board to the septum. The adhesive may be spread or sprayed onto the septum. The board may then be pressed onto the adhesive, which is then allowed to dry or cure. Thus, the board may be affixed to the septum.

The panel may also include a covering. The covering may be any fabric suitable for the purpose of adding aesthetic value to the assembly, such as cloth or vinyl, for example. The covering may be wrapped around the septum, and secured to the back side of the septum, for example, via an adhesive or other securing means, such as a staple or tack for example. The covering may be wrapped tightly enough around the board so that friction holds the board against the septum. Accordingly, an adhesive may not be necessary to affix the board to the septum.

Another embodiment of a prior art panel may include a molded fiberglass board wrapped in a covering. The molded fiberglass board may be a tackable substrate, having a thickness in a range of about ⅛-½″, and a density in a range of about 12-22 lbs/ft³.

The covering may be any fabric suitable for the purpose of adding aesthetic value to the assembly. The covering may be wrapped around the board, and secured to the back side of the board, for example, via an adhesive or other securing means, such as a staple or tack for example.

Though the use of molded fiberglass as a tackable substrate is well-known, it is also well-known that the use of molded fiberglass may be undesirable for a number of reasons. For example, molded fiberglass may be a contaminant and may, therefore, tend to devalue the finished product. Additionally, fiberglass may be a skin irritant and may tend to cause people to itch, so protective clothing is often required. Also, molded fiberglass is produced in sheet form and is, therefore, expensive compared to a product available in roll form. During the manufacturing process, people may be exposed to fiberglass dust and/or emissions from spray adhesives. Fiberglass also typically includes formaldehyde, which is may prevent a manufacturer from securing so-called “Green Guard” approval. Green Guard is a well-known environmental standard.

Fiberglass does, however, provide fire ratings that are necessary or desirable for walls or office partitions. It would be desirable, therefore, if tackable furniture panels were available that could reduce the use of fiberglass and spray adhesives, while maintaining desirable fire ratings.

### SUMMARY OF THE INVENTION

A furniture panel having a tackable surface, may include a rigid core layer, which may include a fiberglass layer, a tackable foam layer affixed to the rigid core layer, and a covering material affixed to the rigid core layer that at least partially covers a tackable surface of the foam layer. The tackable foam layer may comprise a cross-linked, closed-cell, polyolefin foam, which may be a polypropylene foam. The tackable foam layer may have a thickness of about 1 to 6 mm, a density of about 1.5 to 4 lb/ft³, a compressive strength of more than about 0.3 kg/cm², and a gel fraction of about 30-40%.

The tackable foam layer may be adhered to the rigid core layer, via a pressure sensitive adhesive, for example. The covering may be wrapped around the tackable foam layer and the rigid core layer sufficiently tightly to affix the tackable foam layer to the rigid core layer via friction between the tackable foam layer and the rigid core layer. The furniture panel may include a frame that receives the tackable foam layer and the rigid core layer such that the tackable foam layer is affixed to the rigid core layer.

A substrate having a tackable surface may include a tackable foam sheet and a pressure sensitive adhesive layer affixed to the tackable foam sheet. The pressure sensitive adhesive layer may include a pressure sensitive adhesive and a release backing.

A substrate having a tackable surface may include a rigid fiberglass core layer and a tackable foam layer affixed to the fiberglass core layer. The tackable foam layer may be adhered to the rigid core layer, via a pressure sensitive adhesive, for example.

### BRIEF DESCRIPTION OF THE DRAWINGS

FIGS. 1-3 provide cross-sectional views of example embodiments of tackable systems having foam substrates.

FIGS. 4A and 4B provide front and cross-sectional views, respectively, of a tackable system having a foam substrate and a frame.

FIG. 5 is a flowchart of an example method for manufacturing a tackable foam panel having a foam substrate.

### DETAILED DESCRIPTION OF ILLUSTRATIVE EMBODIMENTS

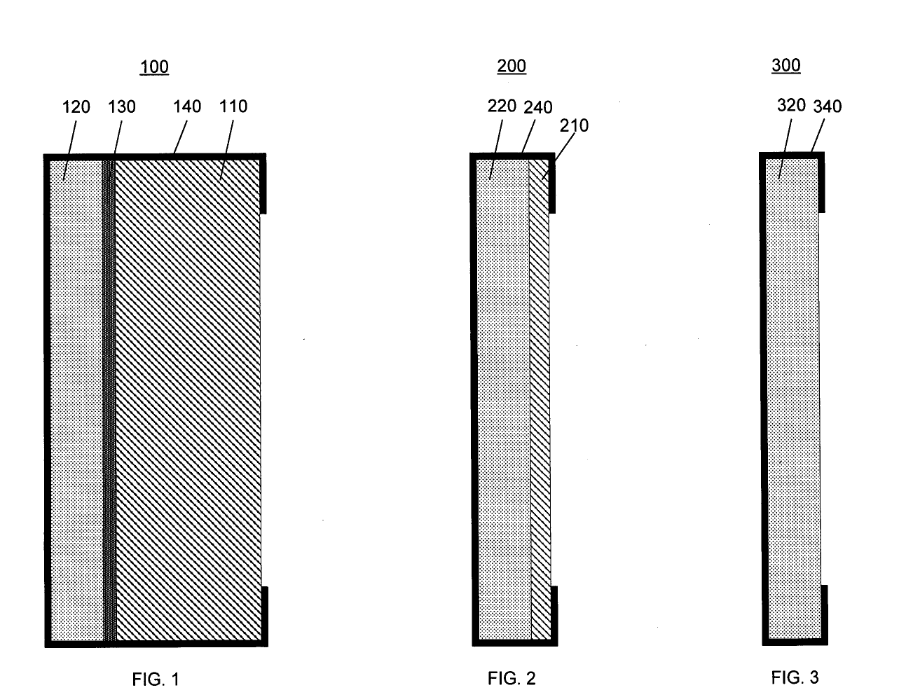

FIG. 1 provides a cross-sectional view of a tackable furniture panel 100. As shown, the panel 100 may have a core layer 110. The core layer 110 may be a rigid core layer, and may include fiberglass. The core layer 110 may have a thickness of about ½-2″ and a density of about 1.5 to 6 lbs/ft³. Examples of such fiberglass include rotary-processed fiberglass, such as Owens Corning's RA and Johns Manville's SG products. More generally, the core layer could be any rigid layer, and may be made of any material, such as masonite, MDF, plywood, foam, etc.

The panel 100 may include a tackable foam layer 120 affixed to the core layer 110. An example of a material that provides good tackability is a cross-linked, closed-cell polyolefin foam. Such a foam may be made from a polypropylene or polyethylene resin. It has been found that cell size may affect tackability, i.e., the smaller the cell size, the better the tackability. For example, because closed-cell polyethylene foams typically have larger cell size than closed-cell polypropylene foams, closed-cell polypropylene foams typically provide better tackability than closed-cell polyethylene foams.

Though the foam layer may have any thickness, the foam layer may have a thickness of about 1-6 mm, or of about 2.8-3.4 mm, or of about 3.1 mm. It has been found that thickness may affect tackability, i.e., the thicker the material, the better the tackability. For example, it has been found that, for a given material, a layer having a thickness of 3 mm provides better tackability than a layer having a thickness of 2 mm.

Though the foam layer may have any density, the foam layer may have a density of about 1.5-4.0 lb/ft³, or of about 1.8-2.2 lb/ft³ (0.028-0.038 g/cm³), or of about 2.0 lb/ft³ (0.033 g/cm³). Though the foam layer may have any gel fraction, the foam layer may have a gel fraction of about 30-40% (DFP method). Though the foam layer may have any compressive strength, the foam layer may have a compressive strength of more than about 0.3 kg/cm². Though the foam layer may have any tensile strength, the foam layer may have a tensile strength of more than about 5.0 kg/cm² (machine direction “MD”), or more than about 4.0 kg/cm² (transverse direction “TD”). Though the foam layer may have any elongation, the foam layer may have an elongation of more than about 200% (MD), or more than about 200% (TD). Though the foam layer may have any tear strength, the foam layer may have a tear strength of more than about 2 kg/cm (MD), or more than about 3 kg/cm (TD). Though the foam layer may have any thermal stability, the foam layer may have a thermal stability of about −20 to zero % (MD) and of about −15 to zero % (TD). Though the foam layer may have any thermoforming ratio, the foam layer may have a thermoforming ratio of more than about 0.52.

It may be desirable, especially for office furniture applications, that the foam have a fire rating in accordance with ASTME 84 Class I.

A pressure sensitive adhesive (PSA) 130 may be used to adhere the foam layer 120 to the core layer 110. Examples of such a PSA include a rubber-based or acrylic PSA from 3M, Avery, or Coating and Converting Technologies. The PSA 130 may be applied to the foam layer 120. The foam layer 120 may then be pressed onto the core layer 110. Alternatively, a wet applied adhesive may be spread or sprayed onto the core 110. The foam layer 120 may then be pressed onto the adhesive, which may then be allowed to dry or cure. Thus, the foam layer 120 may be affixed to the core layer 110.

It has been found that the use of an adhesive, such as 0.003″ PSA, for example, improves the tackability of the panel 100. As a tack is pressed into the foam layer, the end portion of the tack may pass through the foam layer and into the adhesive layer. The adhesive tends to adhere to the end portion of the tack, thus tending to hold the tack in place (i.e., to keep the tack from falling out or moving significantly).

The panel 100 may also include a covering 140, which may be a fabric such as cloth or vinyl, for example. The covering 140 may be wrapped around the foam layer 120, and secured to the back side of the core layer 110. The covering may be adhered to the back side of the core layer 110, or it may be secured via other securing means, such as a staple, tack, screw, or the like. Alternatively or additionally, the covering 140 may be secured to the foam layer 120. The covering 140 may be adhered to the foam layer 120, or it may be secured via other securing means, such as a staple, tack, screw, or the like.

It should be understood that the covering 140 may be wrapped tightly enough around the foam layer 120 such that friction between the foam layer 120 and the core layer 110 affixes the foam layer 120 and the core layer 110 to one another. Accordingly, an adhesive may not be necessary to affix the foam layer 120 to the core layer 110.

The covering may also improve the tackability of the panel 100. As a tack is pressed through the covering 140 and into the foam layer 120, the covering 140 may grab onto the prong of the tack and help to retain the tack in the panel 100.

Thus, the panel 100 may be considered a tackable panel, having one or more tackable surfaces for receiving a tack, and comprising one or more tackable materials for holding a tack.

FIG. 2 provides a cross-sectional view of another embodiment of a tackable furniture panel 200. The panel 200 may include a foam layer 220 affixed to a core layer 210. The foam layer 220 may be a tackable foam layer such as described above in connection with the embodiment depicted in FIG. 1. The core layer 210 may be a septum, which may be a chipboard, wallboard, cardboard, metal plate, etc. Typically, such a septum 210 may have a thickness in a range of about ⅛-3″. A pressure-sensitive adhesive or wet adhesive, such as described above and not shown in FIG. 2, may be used to adhere the foam layer 220 to the septum 210.

The panel 200 may also include a covering 240, such as described above in connection with the embodiment depicted in FIG. 1. The covering 240 may be wrapped around the septum 210, and secured to the back side of the septum 210, for example, via an adhesive or other securing means, such as a staple, screw, or tack for example. The covering 240 may be wrapped tightly enough around the foam layer 220 so that friction holds the foam layer 220 against the septum 210. Accordingly, an adhesive may not be necessary to affix the foam layer 220 to the septum 210.

FIG. 3 provides a cross-sectional view of another embodiment of a tackable furniture panel 300. The panel 300 may include a covering 340, such as described above in connection with the embodiment depicted in FIG. 1, that is wrapped around a tackable foam layer 320, such as described above in connection with the embodiment depicted in FIG. 1. The covering 320 may be secured to the back side of the foam layer 320, for example, via an adhesive or other securing means, such as a staple, screw, or tack for example.

Any of the embodiments depicted in FIGS. 1-3 could include a frame (not shown in FIGS. 1-3) that receives the tackable foam layer, the covering, and, if present, the core layer. The frame may be adapted to hold the covering tightly against the foam layer, such that no adhesive or other securing means is necessary to affix the covering to the foam layer. Similarly, the frame may be adapted to hold the foam layer tightly against the core layer, such that no adhesive is necessary to affix the foam layer to the core layer.

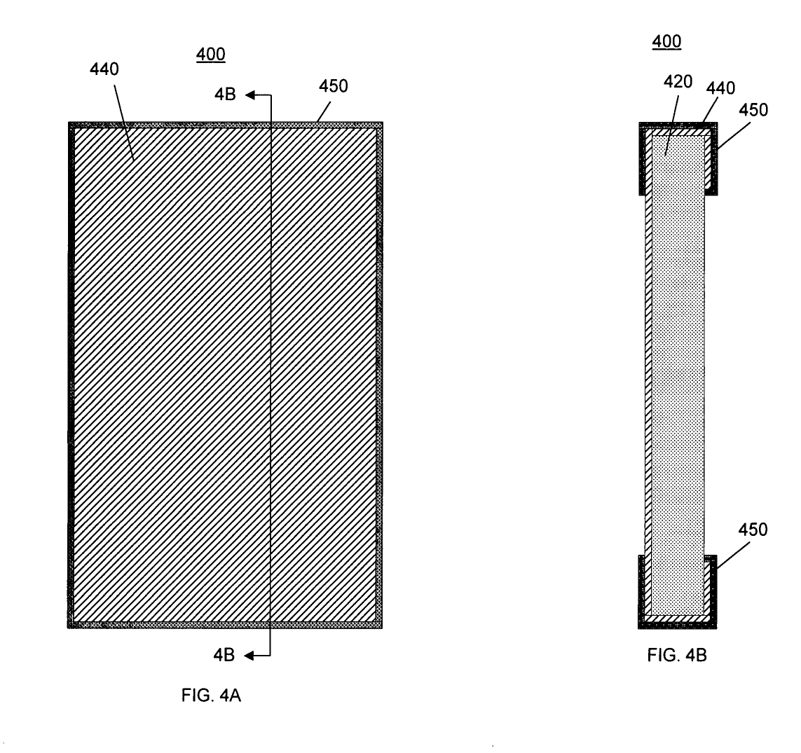

FIGS. 4A and 4B are front and cross-sectional views, respectively, of a tackable furniture panel 400 with a frame 450. As shown, the panel 400 may include a tackable foam layer 420 and a covering 440. As shown, the frame 450 extends around the entire perimeter of the panel 400. It should be understood, however, that the frame 450 may extend around only part of the perimeter of the foam layer 420. It should be understood that the panel 400 could also include a core layer, such as a septum or fiberglass layer, which could also be received into the frame. It should further be understood that the panel may include one or more adhesive layers to, for example, adhere the covering 440 to the foam layer 420, or to adhere the foam layer 420 to a core layer.

A panel 400 such as depicted in FIGS. 4A and 4B may be particularly suitable for use as a tackboard in place of a more traditional corkboard. Where a core layer is included, the panel may be particularly suitable for use as an office partition, especially where the foam has a fire rating in accordance with ASTME 84 Class I.

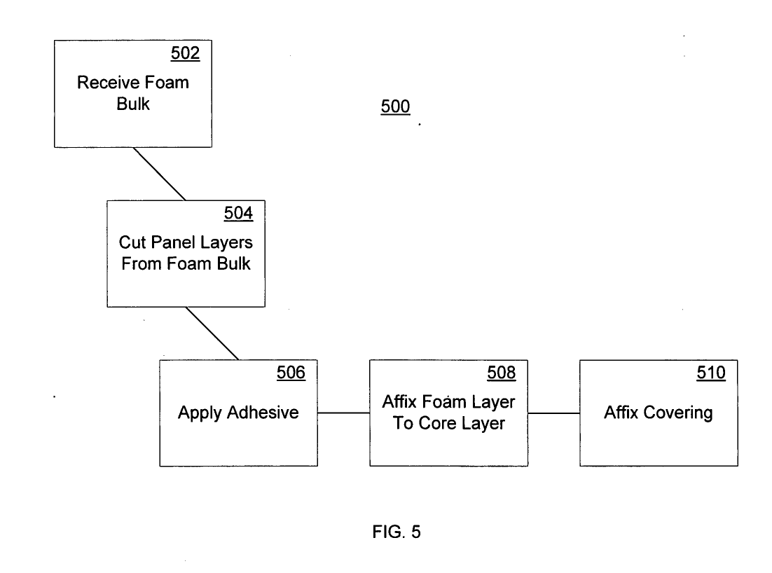

FIG. 5 is a flowchart of a example method 500 for manufacturing a tackable panel having a foam substrate. At 502, a bulk of foam may be received, the foam having properties, as described above, that enable it to be used as a tackable substrate. The bulk of foam may be a roll or a sheet (a roll may be thought of as a large sheet that is rolled). A typical foam roll may have any width, typically up to 120″.

At 504, the bulk of foam may be “cut to size” for a particular application. For example, one or more panel layers may be cut from the bulk of foam. The dimensions of a particular panel layer may depend on the product in which the layer is to be incorporated. A typical foam layer for an office partition may be 30″×60″, for example, though such layers may be made to order for each customer's specific requirements. A typical foam layer for a stretch wall may be 48″×96″ or 48″×120″, for example, though such layers may be made to order for each customer's specific requirements.

At 506, a pressure-sensitive adhesive (PSA) layer may be applied to the panel layer. The PSA layer may include a pressure sensitive adhesive applied to a release backing. The PSA layer may be applied to the bulk of foam before it is cut to size, or to individual panel layers after they are cut from the bulk. A foam panel layer having such a PSA layer applied thereto may be stored, or shipped to another location, for later use in fabricating a product having a tackable foam substrate. Thus, the need for a messy spray or roll-on wet-applied adhesive by the customer could be eliminated.

At 508, the foam panel layer may be affixed to a fiberglass core layer. The release backing on the PSA layer can be peeled away, and the foam layer, with the PSA, can be pressed onto the core. Alternatively, an adhesive layer may be sprayed or spread onto the foam layer or the core layer to adhere the foam to the core by the customer.

At 510, a covering may be applied to the substrate. The covering may be stretched tightly around the foam layer (and core layer, if present). The covering may be glued to either the foam layer or the core layer, or otherwise attached using a securing means, such as a staple, screw, or tack, for example. A frame may be used to affix the covering material to the substrate. Such a frame may be particularly desirable for office partition applications, as such a frame typically adds strength and structure.

What is claimed:

1. A furniture panel having a tackable surface, the furniture panel comprising:
a rigid fiberglass core layer;
a tackable foam layer affixed to the rigid core layer; and
a covering material affixed to the rigid core layer that at least partially covers a tackable surface of the foam layer.

2. The furniture panel of claim 1, wherein the tackable foam layer comprises a cross-linked, closed-cell, polyolefin foam.

3. The furniture panel of claim 2, wherein the foam is a polypropylene foam.

4. The furniture panel of claim 2, wherein the tackable foam layer has a thickness of about 1 to 6 mm, a density of about 1.5 to 4 lb/ft³, and a compressive strength of more than about 0.3 kg/cm².

5. The furniture panel of claim 4, wherein the tackable foam layer has a thickness of about 2.8 to 3.4 mm.

6. The furniture panel of claim 4, wherein the tackable foam layer has a density of about 1.7 to 2.3 lb/ft³.

7. The furniture panel of claim 4, wherein the tackable foam layer has a gel fraction of about 30-40%.

8. The furniture panel of claim 4, wherein the tackable foam layer has a thickness of about 2.8 to 3.4 mm, a density of about 1.7 to 2.3 lb/ft³, and a gel fraction of about 30-40%.

9. The furniture panel of claim 1, wherein the tackable foam layer is adhered to the rigid core layer via a pressure sensitive adhesive.

10. The furniture panel of claim of claim 1, wherein the tackable foam layer has a fire rating in accordance with ASTME 84 Class I.

11. The furniture panel of claim 1, wherein the covering is wrapped around the tackable foam layer and the rigid core layer sufficiently tightly to affix the tackable foam layer to the rigid core layer via friction between the tackable foam layer and the rigid core layer.

12. The furniture panel of claim 1, further comprising:
a frame that receives the tackable foam layer and the rigid core layer such that the tackable foam layer is affixed to the rigid core layer.

13. A substrate having a tackable surface, comprising:
a tackable foam sheet; and
a pressure sensitive adhesive layer affixed to the tackable foam sheet, the pressure sensitive adhesive layer comprising a pressure sensitive adhesive and a release backing.

14. A substrate having a tackable surface, the substrate comprising:
a rigid fiberglass core layer; and
a tackable foam layer affixed to the rigid fiberglass core layer.

15. The substrate of claim 14, wherein the tackable foam layer comprises a cross-linked, closed-cell, polyolefin foam.

16. The substrate of claim 15, wherein the foam is a polypropylene foam.

17. The substrate of claim 16, wherein the tackable foam layer has a thickness of about 1 to 6 mm, a density of about 1.5 to 4 lb/ft³, and a compressive strength of more than about 0.3 kg/cm².

18. The substrate of claim 17, wherein the tackable foam layer has a thickness of about 2.8 to 3.4 mm, a density of about 1.7 to 2.3 lb/ft³, and a gel fraction of about 30-40%.

19. The substrate of claim 14, wherein the tackable foam layer is adhered to the rigid core layer via a pressure sensitive adhesive.

20. The substrate of claim 14, wherein the tackable foam layer has a fire rating in accordance with ASTME 84 Class I.
